(19) United States
(12) Patent Application Publication
(10) Pub. No.: US 2009/0198785 A1
(43) Pub. Date: Aug. 6, 2009

(54) MAIL SENDING AND RECEIVING APPARATUS, METHOD, COMPUTER-READABLE MEDIUM, AND SYSTEM

(75) Inventors: Atsushi UCHIYAMA, Nagano (JP); Jun YAMAZAKI, Nagano (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/358,988

(22) Filed: Jan. 23, 2009

(30) Foreign Application Priority Data
Jan. 23, 2008 (JP) 2008-012089

(51) Int. Cl. G06F 15/16; H04L 9/32; G06F 21/00

(52) U.S. Cl. 709/206; 726/7

(57) ABSTRACT

A method to facilitate sending and receiving e-mails, the method including: providing a memory including mail-status-information indicating whether a received e-mail has been opened; detecting opening of the received e-mail; updating the mail status information stored in the memory upon detection of the opening of the received e-mail; accepting a status request for the mail status information; and reading the mail status information from the memory and providing the same upon acceptance of the status request.

### CROSS-REFERENCE TO RELATED APPLICATIONS

This application is based upon and claims the benefit of priority of the prior Japanese Patent Application No. 2008-012089, filed on Jan. 23 2008, the entire contents of which are incorporated herein by reference.

### FIELD

The present embodiment discussed herein is directed to mail sending and receiving programs, mail sending and receiving apparatuses, and mail sending and receiving systems for sending and receiving e-mails.

### BACKGROUND

The present techniques relate to mail sending and receiving programs, mail sending and receiving apparatuses, and mail sending and receiving systems for sending and receiving e-mails. Particularly, the present techniques relate to a mail sending and receiving program, a mail sending and receiving apparatus, and a mail sending and receiving system with which it is possible to manage a mail account shared by a plurality of users.

In some cases, a Web mail function is implemented in groupware or the like used within an organization. In existing Web mail systems, special functions are not provided particularly for management at a representative address.

The present techniques relate to a mail sending and receiving program, a mail sending and receiving apparatus, and a mail sending system with which it is possible to manage the status of opening of e-mails received at a mail account shared by a plurality of users.

With popularization of e-mails, state institutions, local governments, private companies, and other organizations have been using more and more e-mails for sending and receiving information to and from within and outside the organizations.

These organizations use mail addresses of the organization for contacting to the organization as a whole or mail addresses of subgroups of the organization (e.g., a department, a division, and a project team) for contacting to the subgroups (hereunder called representative addresses) in addition to personal mail address of persons in charge.

Regarding to this, a technique to transfer an e-mail directed to a representative address to registered multiple addresses as a broad cast mail are known (e.g., refer to a patent document 1, Japanese Laid-open Patent Publication No. 2002-82876). This allows confirming and sharing the content of the e-mail received at the representative address throughout the subgroup.

There is a webmail software (hereunder, called “web mail”) to read electronic mails on a browser software instead of on a mailer software. Using a webmail can ensure security, because all messages are managed by a server-side.

Patent document 1, Japanese Laid-open Patent Publication No. 2002-82876

### SUMMARY

An embodiment of the invention provides a method to facilitate sending and receiving e-mails, the method including: providing a memory including mail-status-information indicating whether a received e-mail has been opened; detecting opening of the received e-mail; updating the mail status information stored in the memory upon detection of the opening of the received e-mail; accepting a status request for the mail status information; and reading the mail status information from the memory and providing the same upon acceptance of the status request.

### BRIEF DESCRIPTION OF THE DRAWINGS

FIG. 1 is a diagram showing an overview of an embodiment;

FIG. 2 is a diagram showing the system configuration according to the embodiment;

FIG. 3 is a diagram showing the hardware configuration of a mail server;

FIG. 4 is a block diagram showing functions of the mail server;

FIG. 5 is a diagram showing the data structure of an association table;

FIG. 6 is a diagram showing the data structure of a group table;

FIG. 7 is a diagram showing the data structure of an address table;

FIG. 8 is a diagram showing the data structure of a mail management table;

FIG. 9 is a diagram showing the data structure of a status management table;

FIG. 10 is a diagram showing the data structure of a comment management table;

FIG. 11 is a flowchart showing the procedure of a mail reading process;

FIG. 12 is a sequence diagram showing the procedure of a process of displaying opening information and reply information of an e-mail in a mail system;

FIG. 13 is an illustration showing a log-in screen;

FIG. 14 is an illustration showing a post-log-in screen;

FIG. 15 is an illustration showing a received-mail display screen;

FIG. 16 is an illustration showing a reply-mail creating screen;

FIG. 17 is an illustration showing a comment creating screen;

FIG. 18 is an illustration showing an opening-status display screen;

FIG. 19 is an illustration showing a reply-history display screen;

FIG. 20 is an illustration showing a comment display screen; and

FIG. 21 is an illustration of a mail-status display screen.

### DETAILED DESCRIPTION OF EMBODIMENT

Now, an embodiment will be described with reference to the drawings.

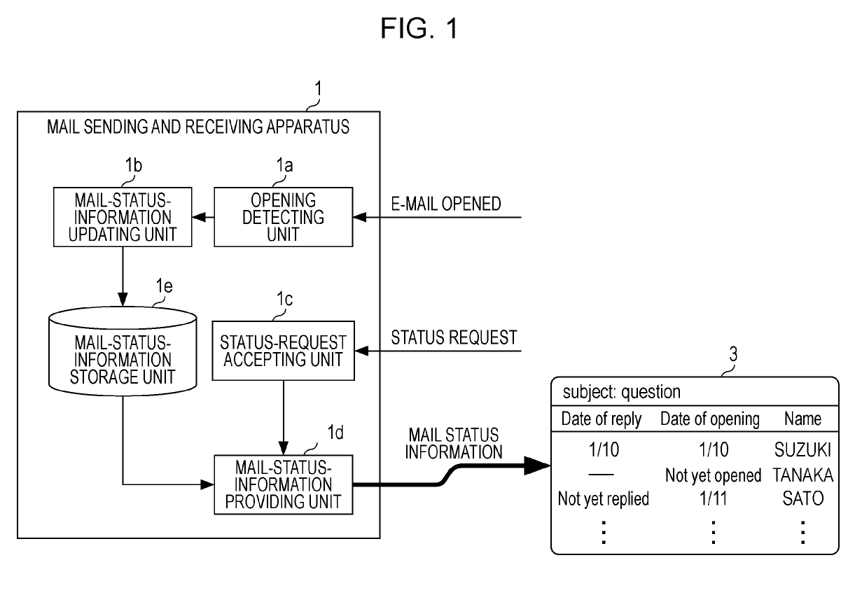

FIG. 1 is a diagram showing an overview of the embodiment. A mail sending and receiving apparatus shown in FIG. 1 sends and receives e-mails. Furthermore, the mail sending and receiving apparatus manages the status of opening of e-mails received at a mail account shared by a plurality of users. A mail sending and receiving apparatus 1 is implemented by a computer functioning as described below according to a mail sending and receiving program. The mail sending and receiving apparatus 1 sends and receives e-mails and manages the status of opening of e-mails received at a mail account shared by a plurality of users. The mail sending and receiving apparatus 1 includes opening detecting unit 1a, mail-status-information updating unit 1b, status-request accepting unit 1c, mail-status-information providing unit 1d, and mail-status-information storage unit 1e.

The opening detecting unit 1a detects opening of the received e-mail by a user's operation. The opening of the e-mail refers to the first time of reference of the e-mail by a user's operation of browser software or mailer software to display the content of the e-mail on a display screen. Upon opening of the e-mail, the e-mail is thereafter considered as having been read by the user who opened the e-mail.

Upon detection of the opening of a received e-mail by the opening detecting unit 1a, in accordance with the opening detected, the mail-status-information updating unit 1b updates mail status information stored in the mail-status-information storage unit 1e.

The status-request accepting unit 1c accepts a status request for requesting that mail status information be provided. The status request is issued by a user who wishes to check the status of opening of an e-mail in order to display the status of opening of the e-mail on a display screen 3.

In response to the status request accepted by the status-request accepting unit 1c, the mail-status-information providing unit 1d reads mail status information from the mail-status-information storage unit 1e and provides the mail status information. On the basis of the mail status information provided from the mail-status-information providing unit 1d, the status of opening of an e-mail that the user wishes to check is displayed on the display screen 3 so that the user can check the status of opening of the e-mail.

The mail-status-information storage unit 1e stores mail status information indicating whether each e-mail received by the mail sending and receiving apparatus 1 has been opened.

According to the mail sending and receiving apparatus 1 described above, the opening detecting unit 1a detects the opening of a received e-mail. In accordance with the opening detected, the mail-status-information updating unit 1b updates the mail status information. The status-request accepting unit 1c accepts a status request. In response to the status request, the mail-status-information providing unit 1d reads the mail status information and provides the mail status information.

Accordingly, it is possible to recognize the status of opening of e-mails at a mail account shared by a plurality of users. Thus, it is readily possible to manage the status of reading of e-mails by the users at the shared mail account.

Now, the embodiment will be described in detail with reference to the drawings.

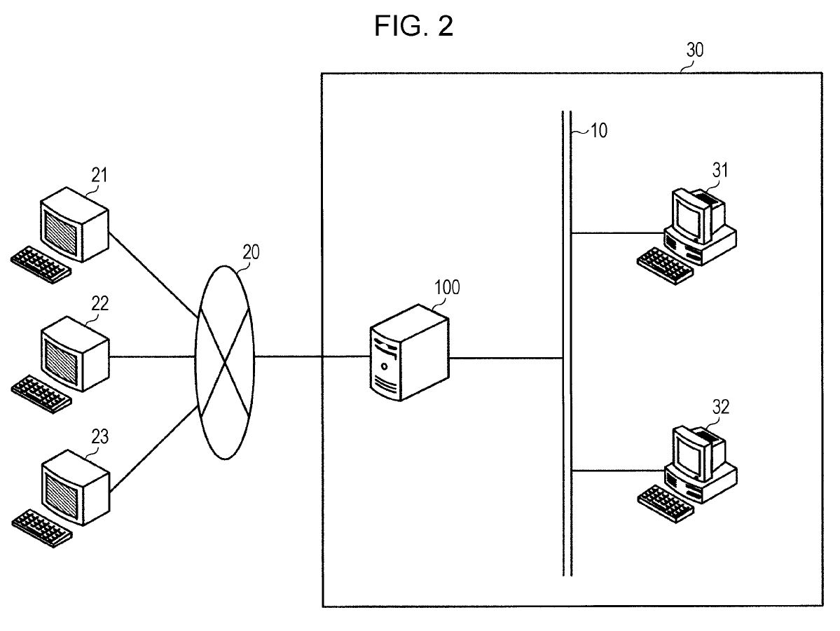

FIG. 2 is a diagram showing the system configuration of the embodiment. A mail system shown in FIG. 2 is a system for sending and receiving e-mails within an organization 30 and between the inside of the organization 30 and the outside (terminal apparatuses 21, 22, 23, . . .) of the organization 30.

The scope of an organization is defined as appropriate. In the case of a company, for example, a department may be considered as an organization, or the entire company may be considered as an organization. Similarly, in the case of a local government, for example, a section may be considered as an organization, or the entire government may be considered as an organization.

In the mail system according to this embodiment, terminal apparatuses 31, 32, . . . are connected via a local area network (LAN) 10 to a mail server 100 for sending and receiving e-mails. Furthermore, the mail server 100 is connected to external terminal apparatuses 21, 22, 23, . . . via the Internet 20.

The mail server 100 sends and receives e-mails within the organization 30 and between the inside and outside of the organization 30. Furthermore, the mail server 100 manages e-mail accounts within the organization 30.

The mail server 100 has a function of storing internal mails created by users inside the organization 30 by using browsers on the terminal apparatuses 31, 32, . . . . Furthermore, the mail server 100 has a function of receiving e-mails sent from the outside to the inside of the organization 30 via the Internet 20 and storing the e-mails.

Furthermore, the mail server 100 has a function of allowing users as recipients of e-mails, stored in a mail-information storage unit (not shown), to perform operations on the e-mails as Web mails in accordance with requests from the users by using browsers on the terminal apparatuses 31, 32, . . . . The e-mail operations refer to operations relating to management of e-mails, such as creating and sending a new e-mail, reading an e-mail received or sent, creating a reply mail to a received e-mail, deleting an e-mail received or sent at an account being used, and temporarily saving an e-mail being created.

When a user wishes to perform e-mail operations, the user is requested to enter a user ID and a password from a browser on one of the terminal apparatuses 31, 32, . . . , and the user is allowed to perform operations on internal mails written to the user from the inside of the organization 30 and external mails sent to the user from the outside of the organization 30 only when the user ID and password match authentication information registered in advance. On occasion of an e-mail operation, the mail server 100 sends via the LAN 10 information representing the content of an e-mail relevant to the user's operation to the browser of one of the terminal apparatuses 31, 32, . . . (e.g., the terminal apparatus 31) that the user is operating. Upon receiving the information representing the content of the e-mail, the terminal apparatus 31 displays the content of the e-mail on the browser of the terminal apparatus 31. With reference to the content of the e-mail displayed on the browser, the user performs an e-mail operation.

Furthermore, the mail server 100 has a function of sending e-mails created by using the browsers of the terminal apparatuses 31, 32, . . . to the outside via the Internet 20. On occasion of sending of an e-mail, the mail server 100 accepts a user's request for creating and sending an e-mail according to the Hypertext Transfer Protocol (HTTP), and sends the e-mail to a destination (e.g., a user of the terminal apparatus 21) specified by the user according to the Post Office Protocol (POP)/Internet Message Access Protocol (IMAP).

In this embodiment, e-mails that are stored under management by the mail server 100 and that can be operated on browsers by users within the organization 30 only from the terminal apparatuses 31, 32, . . . within the organization 30 are referred to as “Web mails”. Within the organization 30, the users can perform reading and other operations on external mails sent from the outside of the organization 30 to the mail server 100 as well as internal mails as Web mails.

Furthermore, the users belonging to the organization 30 may be allowed to read e-mails on the mail system by connecting to the mail server 100 from external terminal apparatuses (not shown) outside the organization 30 via the Internet 20. Also in this case, similarly to the case of using the terminal apparatuses 31, 32, . . . inside the organization 30, the users belonging to the organization 30 undergo authentication for log in based on user IDs and passwords by using terminals located outside the organization 30 and connected to the Internet 20. Thus, the users belonging to the organization 30 can read e-mails received at a representative address even when the users are outside the organization 30.

E-mails that are created at the terminal apparatuses 31, 32, . . . inside the organization 30 and exchanged among the users inside the organization 30 are referred to as “internal mails”. On the other hand, e-mails exchanged between users inside the organization 30 and the outside of the organization 30 via the Internet 20 and the mail server 100 are referred to as “external mails”.

In this embodiment, “e-mails” include both internal mails and external mails, and also include Web mails.

That is, an internal mail is created on the browser at one of the terminal apparatuses 31, 32, . . . inside the organization 30. The internal mail that has been created is stored in the mail server 100 as a Web mail, and only a user who has logged in by using an account within the organization 30 set as a destination of the internal mail is allowed to perform operations involving the Web mail.

When an external mail is sent from the inside to the outside of the organization 30, a user creates the external mail by using the browser at one of the terminal apparatuses 31, 32, . . . , and in response to a sending instruction by the user, the external mail is sent temporarily from the mail server 100 via the Internet 20 to a mail server (not shown) that manages e-mails of a user at the destination. Then, for example, the external mail is sent from the mail server that manages e-mails of the user at the destination to one of the external terminal apparatuses 21, 22, 23, . . . used by the user at the destination.

As an example, description will be given in the context of a case where a user of the terminal apparatus 31 sends an external mail to a user of the external terminal apparatus 21 by using a mail address corresponding to a mail account managed by the mail server 100. In this case, according to a user's operation performed by using the browser at the terminal apparatus 31, upon creation of an e-mail addressed to the user of the terminal apparatus 21, the terminal apparatus 31 sends a body of the e-mail and a mail address of the user of the terminal apparatus 21 at the destination to the mail server 100 via the LAN 10. Upon receiving the mail address of the user of the terminal apparatus 21 at the destination and the mail body from the terminal apparatus 31, the mail server 100 sends the e-mail created by the user of the terminal apparatus 31 and including the mail body to the destination mail address.

On the other hand, when an external mail sent from the outside of the organization 30 via the Internet 20 is received by the mail server 100, similarly to the case of an internal mail, the external mail is stored at the mail server 100 as a Web mail, and only a user who has logged in by using an account within the organization 30 set as a destination of the external mail is allowed to perform operations involving the Web mail on the browser at one of the terminal apparatuses 31, 32, . . . inside the organization 30.

As described above, the mail server 100 sends information of documents created by users within the organization 30 by using the terminal apparatuses 31, 32, . . . as external mails to the outside of the organization 30, and provides Web mails so that the users within the organization 30 can perform e-mail operations by using the browsers running on the terminal apparatuses 31, 32, . . . and so that other users within the organization 30 can perform operations involving the e-mails created. As described above, the mail server 100 according to this embodiment sends and receives e-mails to and from the inside and outside of the organization 30, and manages received e-mails. With the mail server 100 according to this embodiment, it is possible to send an e-mail to addresses including destinations both inside and outside the organization 30.

Furthermore, in this embodiment, external mails received from the outside of the organization 30 and internal mails are managed at the mail server 100 simply on the basis of source addresses without particular distinction between the external mails and the internal mails, and both the external mails and the internal mails are displayed simultaneously on occasion of a user's operation at one of the terminal apparatuses 31, 32, . . . . Alternatively, however, as needed, external mails and internal mails may be managed distinctly, and may also be displayed distinctly. Yet alternatively, the mail server 100 may be configured to deal with only external mails or only internal mails.

Furthermore, although the mail server 100 has the function of managing Web mails in this embodiment, without limitation to the embodiment, an independent apparatus different from the mail server 100, such as a server dedicated for Web mails, may have a function of managing Web mails, or an apparatus having another function, such as a server, may also have a function of managing Web mails.

The terminal apparatuses 21, 22, 23, . . . are computers provided outside the organization 30 so that users outside the organization 30 can send e-mails, receive e-mails, and perform other operations involving e-mails. Each of the terminal apparatuses 21, 22, 23, . . . has a function of sending and receiving e-mails.

The terminal apparatuses 31, 32, . . . are computers provided inside the organization 30 so that users inside the organization 30 can use Web mails provided by the mail server 100. Each of the terminal apparatuses 31, 32, . . . has a function of using Web mails provided by the mail server 100, and a function of operating the mail server 100 to send e-mails to and receive e-mails from the outside of the organization 30 via the Internet 20.

Next, the hardware configuration of the mail server 100 will be described.

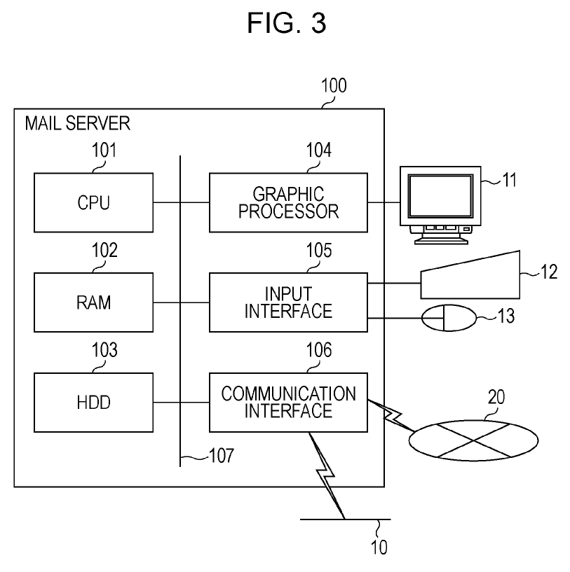

FIG. 3 is a diagram showing the hardware configuration of the mail server 100. The mail server 100 as a whole is controlled by a central processing unit (CPU) 101. The CPU 101 is connected to a random access memory (RAM) 102, a hard disk drive (HDD) 103, a graphic processor 104, an input interface 105, and a communication interface 106.

The RAM 102 temporarily stores at least part of an operating system (OS) program and application programs executed by the CPU 101. Furthermore, the RAM 102 stores various types of data needed for processing by the CPU 101. The HDD 103 stores the OS and application programs.

The graphic processor 104 is connected to a monitor 11. The graphic processor 104 displays images on a screen of the monitor 11 according to instructions from the CPU 101. The input interface 105 is connected to a keyboard 12 and a mouse 13. The input interface 105 sends signals sent from the keyboard 12 or the mouse 13 to the CPU 101 via a bus 107.

The communication interface 106 is connected to networks such as the LAN 10 and the Internet 20. The communication interface 106 sends data to and receives data from other computers via these networks.

The processing functions according to this embodiment can be implemented by the hardware configuration described above.

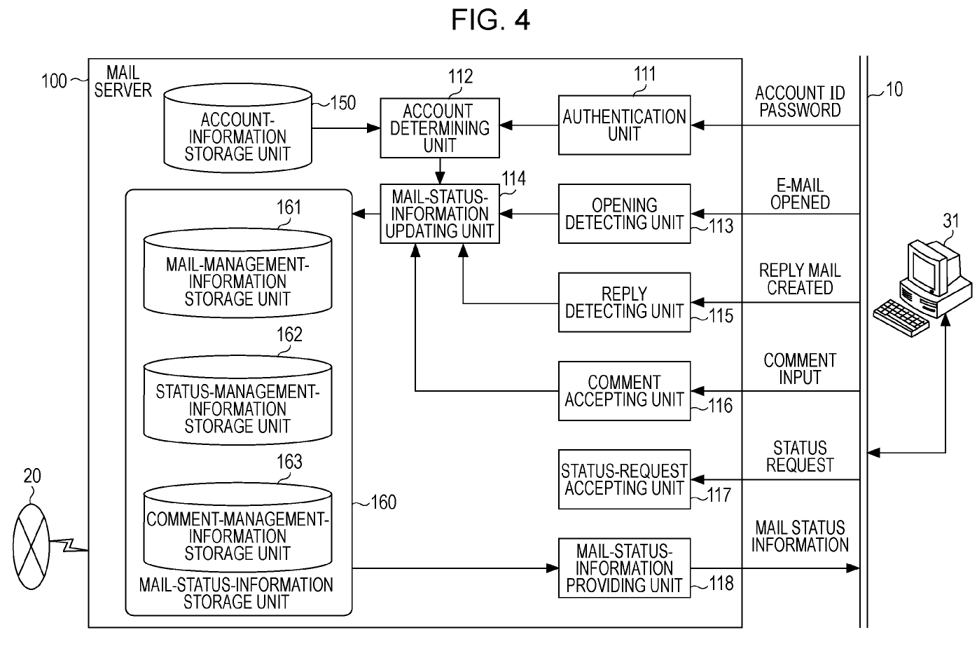

Next, the module configuration of the mail server 100 will be described. FIG. 4 is a block diagram showing the functions of the mail server 100. The mail server 100 sends and receives e-mails, and manages the status of opening of e-mails received at a representative address, i.e., e-mails at a mail account shared by a group of a plurality of users. For the purpose of management of the status of opening of e-mails received at the representative address, the mail server 100 includes an authentication unit 111, an account determining unit 112, an opening detecting unit 113, a mail-status-information updating unit 114, a reply detecting unit 115, a comment accepting unit 116, a status-request accepting unit 117, a mail-status-information providing unit 118, an account-information storage unit 150, and a mail-status-information storage unit 160.

Furthermore, the mail server 100 is connected via the LAN 10 to the terminal apparatus 31, at which a user manages e-mails, and is connected via the Internet 20 to the external terminal apparatuses 21, 22, 23, . . . (see FIG. 2).

The authentication unit 111, in order to ensure the validity of log in by a user, performs authentication for user's log in to an account for managing e-mails on the basis of an account ID such as a user ID and a password associated with the account ID input to the terminal apparatus 31. Upon successful authentication, the mail server 100 permits log in by the user using the terminal apparatus 31, and provides mail information on the basis of the account corresponding to the account ID used for authentication. Thus, the user can perform, by using the terminal apparatus 31, management such as reading, deletion, and creation of e-mails, creation of reply mails, and creation of comments, which will be described later.

The account determining unit 112 reads account information from the account-information storage unit 150, and with reference to the account information, determines an account at which the user authenticated by the authentication unit 111 is allowed to read e-mails, open e-mails, and perform other operations.

In this mail system, even the authenticated user is not allowed to perform operations involving e-mails at accounts other than the account determined (permitted) by the account determining unit 112. The determination of an account at which the user is allowed to open e-mails will be described later.

The opening detecting unit 113 detects opening of an e-mail received at the representative address corresponding to the account determined by the account determining unit 112 by an operation by the user authenticated by the authentication unit 111, and the user who performed the operation for opening the e-mail. The opening of the e-mail refers to the first time of reference by a user's operation on the browser of one of the terminal apparatuses 31, 32, . . . to display the content of the e-mail on a display screen. Upon the opening of the e-mail, the e-mail is thereafter considered as having been read by the user who opened the e-mail.

Upon the opening detecting unit 113 detecting the opening by the user authenticated by the authentication unit 111 of the e-mail received at the representative address corresponding to the account determined by the account determining unit 112 and the user who opened the e-mail, the mail-status-information updating unit 114 updates the mail status information on the basis of the opening and the user detected. Accordingly, the opening of the e-mail by the user on the browser of one of the terminal apparatuses 31, 32, . . . and the user who opened the e-mail are reflected on the mail status information stored at the mail server 100.

Upon the reply detecting unit 115 detecting a reply by a user to the e-mail received at the representative address corresponding to the account determined by the account determining unit 112, the mail-status-information updating unit 114 updates reply history information included in mail status information on the basis of the reply detected, the user who sent the reply, and the date and time of the reply.

Furthermore, upon the comment accepting unit 116 accepting input of comment by a user to the e-mail received at the representative address corresponding to the account determined by the account determining unit 112, the mail-status-information updating unit 114 updates comment information included in the mail status information on the basis of the comment accepted, the user who input the comment, and the date and time of the input of the comment.

Furthermore, upon the opening detecting unit 113 detecting the opening of the e-mail received at the representative address, the mail-status-information updating unit 114 updates opening date and time information included in the mail status information on the basis of the opening detected and the date and time of the opening.

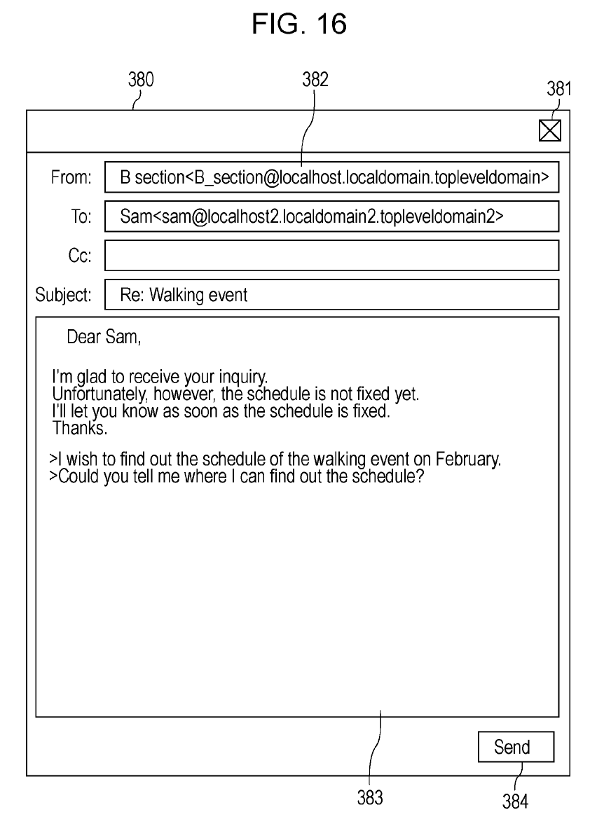

The reply detecting unit 115 detects sending of a reply mail by a user (reply to the received e-mail) to the e-mail received at the representative address corresponding to the account determined by the account determining unit 112. The reply to the e-mail received at the representative address will be described later with reference to FIG. 16 showing a reply-mail creating screen 380.

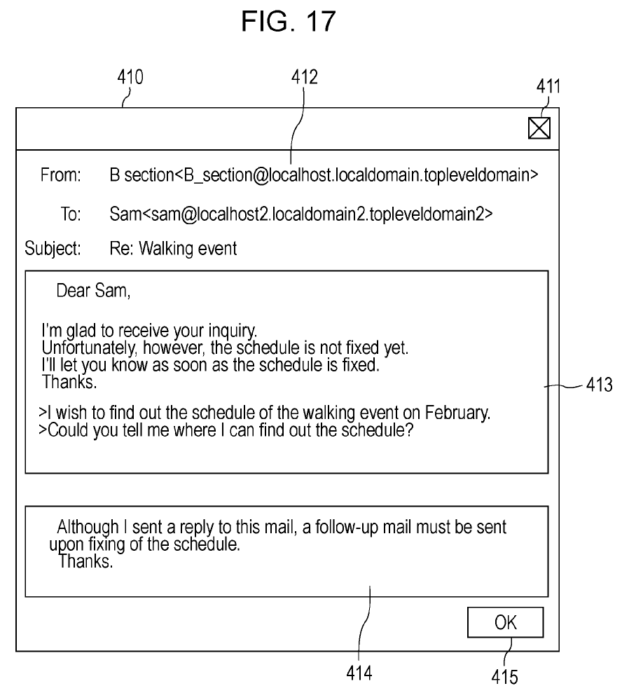

The comment accepting unit 116 accepts input of comment by a user to the e-mail received at the representative address corresponding to the account determined by the account determining unit 112. The input of comment will be described later in detail with reference to FIG. 17 showing a comment creating screen 410.

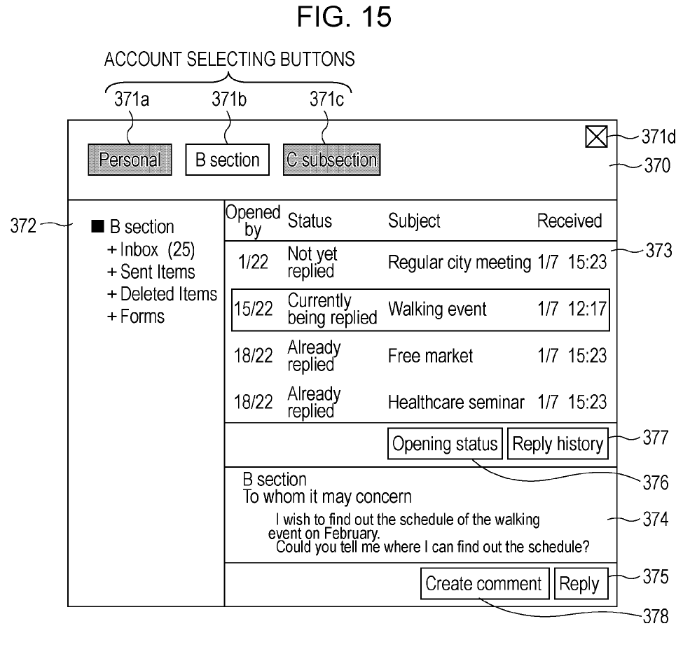

The status-request accepting unit 117 accepts a status request issued by a user to request that mail status information be provided regarding the e-mail received at the representative address corresponding to the account determined by the account determining unit 112. The status request is issued by a user wishing to check the status of opening of the e-mail so that the status of opening of the e-mail is displayed on the display screen 3. The status request is input by a user's operation of the browser of the terminal apparatus 31. The status request input to the terminal apparatus 31 is sent from the terminal apparatus 31 to the mail server 100 via the LAN 10. The operation for the status request will be described later in detail with reference to FIGS. 15 to 21.

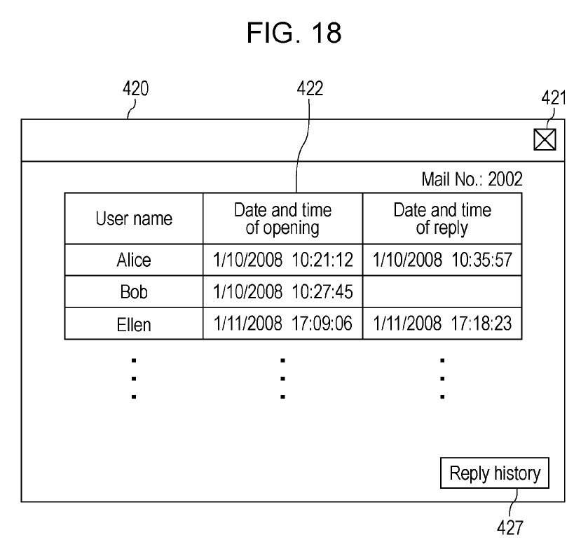

In response to the status request accepted by the status-request accepting unit 117, the mail-status-information providing unit 118 reads mail status information from the mail-status-information storage unit 160, and provides the mail status information via the LAN 10 to one of the terminal apparatuses 31, 32, . . . on which the user checks the status of opening. On the basis of the mail status information provided from the mail-status-information providing unit 118, a screen showing the status of opening of the e-mail that the user wishes to check is displayed on the browser of one of the terminal apparatuses 31, 32, . . . on which the user checks the status of opening of the e-mail. The screen will be described later in detail with reference to FIGS. 18 to 21.

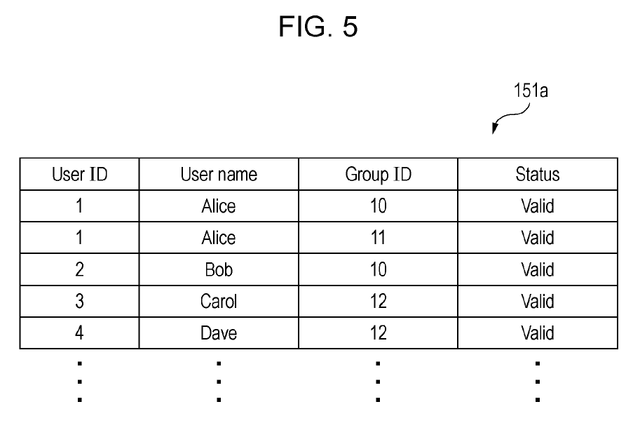

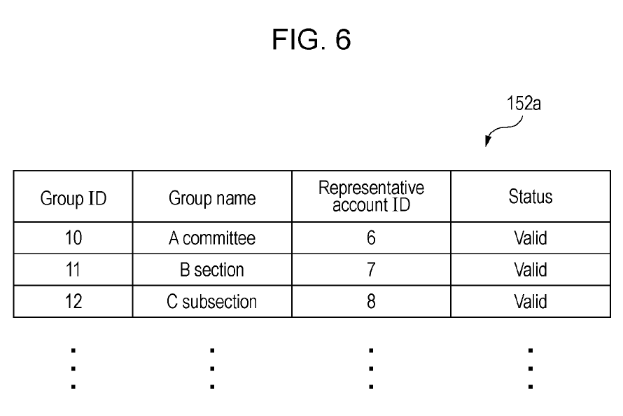

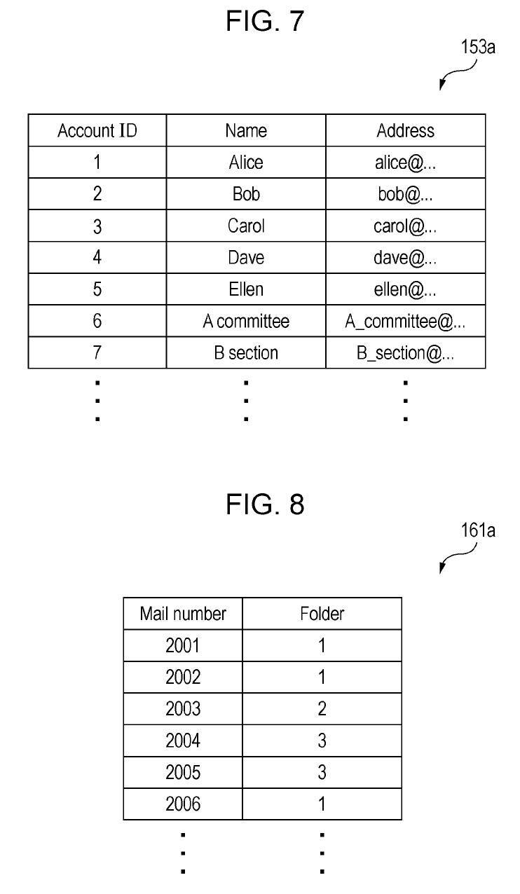

The account-information storage unit 150 stores account information identifying accounts at which users are allowed to perform operations relating to e-mails. The account-information storage unit 150 stores an association table 151a (see FIG. 5), a group table 152a (see FIG. 6), and an address table 153a (see FIG. 7). The account information includes association information stored in the association table 151a, group information stored in the group table 152a, and address information stored in the address table 153a.

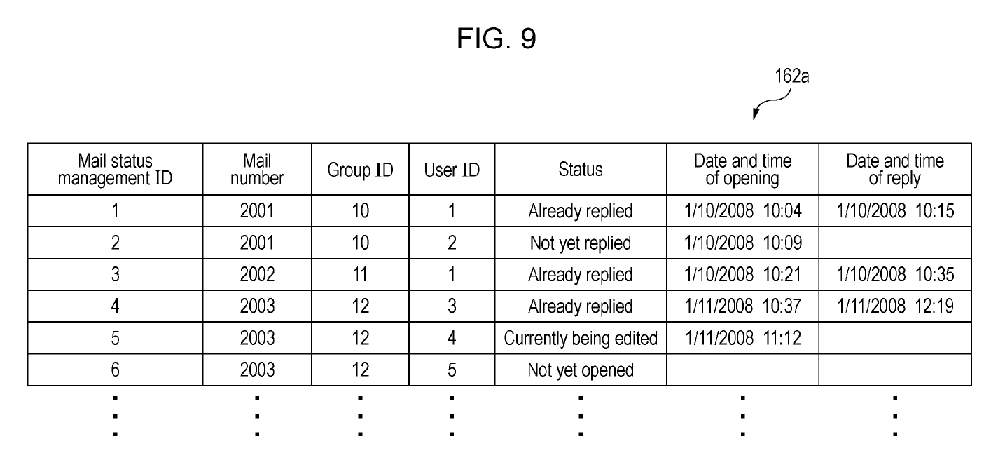

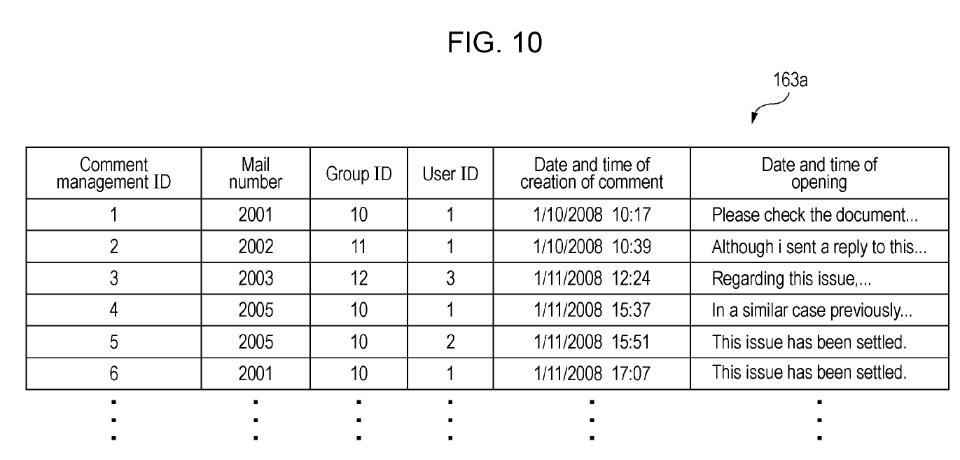

The mail-status-information storage unit 160 stores mail status information indicating whether each e-mail received at the representative address by the mail server 100 has been opened. The mail-status-information storage unit 160 includes a mail-management-information storage unit 161, a status-management-information storage unit 162, and a comment-management-information storage unit 163. The mail-management-information storage unit 161 stores a mail management table 161a (see FIG. 8). The status-management-information storage unit 162 stores a status management table 162a (see FIG. 9). The comment-management-information storage unit 163 stores a comment management table 163a (see FIG. 10).

The mail status information includes opening information indicating whether each e-mail received at the representative address corresponding to the account determined by the account determining unit 112 has been opened by each user authenticated by the authentication unit 111, and indicating each user who opened the e-mail. Furthermore, the mail status information includes reply history information indicating the presence or absence of a reply, i.e., whether a reply mail to each e-mail received at the representative address has been sent, and indicating a user who sent the reply. Furthermore, the mail status information includes comment information indicating comment entered by a user for each e-mail received at the representative address, and indicating the user who created the comment.

Furthermore, the mail status information includes opening date and time information indicating a date and time of opening by a user and the user who opened the e-mail, detected by the opening detecting unit 113, for each e-mail received at the representative address corresponding to the account determined by the account determining unit 112, reply date and time information indicating a date and time of detection by the reply detecting unit 115 of completion of sending of a reply mail by a user, and comment date and time information indicating a date and time of creation of comment by a user for each e-mail received at the representative address corresponding to the account determined by the account determining unit 112.

Furthermore, in order to store information regarding e-mails received at the representative address, the mail server 100 includes a mail-information storage unit (not shown). The mail-information storage unit stores mail information regarding e-mails. The mail information includes mail body and header information of internal mails created on the browser of a terminal apparatus inside the organization 30, such as the terminal apparatus 31, and external mails sent from the outside of the organization 30 via the Internet 20 connected to the mail server 100. The header information includes information indicating a source, a destination, and a date and time of sending.

Furthermore, in order to set a source address indicating a mail address of a source (reply source) to a reply mail, the mail server 100 includes a reply-instruction accepting unit (not shown) and a source-address setting unit (not shown). At an account at which an e-mail has been received, the reply-instruction accepting unit accepts an instruction for creating a reply mail to the e-mail. The source-address setting unit sets an address of the account from which the reply instruction has been accepted by the reply-instruction accepting unit as a source address of a reply mail based on the reply instruction. The screen on the browser of the terminal apparatus 31 and user's operations at the time of setting of the source address will be described later in detail with reference to FIG. 16.

The terminal apparatus 31 is connected to the mail server 100 via the LAN 10. The terminal apparatus 31 outputs a status request to the mail server 100 in response to a user's operation. Furthermore, the terminal apparatus 31 displays a screen showing the status of opening of an e-mail, reply history, and comment based on mail status information provided from the mail-status-information providing unit 118 in response to a user's operation.

In this embodiment, the mail server 100 has the functions described above. Without limitation to the embodiment, however, an independent apparatus different from the mail server 100, such as a dedicated server, may have all the functions described above. Yet alternatively, each of a plurality of apparatuses including the mail server 100 may have part of the functions described above so that the plurality of apparatuses as a whole has the functions described above.

Next, an association table used in the mail server 100 according to this embodiment will be described.

FIG. 5 is a diagram showing the data structure of an association table. The association table 151a shown in FIG. 5 is created and managed by the mail server 100. The association table 151a stores association information indicating corresponding relationship between individual users belonging to the organization 30 and individual groups of the organization 30.

The association table 151a includes “User ID” indicating an identifier (ID) assigned to each user in the organization 30, “user name” indicating a name of the user, “group ID” indicating an ID assigned to a group to which the user belongs, and “status” indicating the validity of the user ID. The items of information in each row are associated with each other to constitute association information. Although not shown in FIG. 5, the association information also includes a password used for authentication of the user in combination with the user ID.

The user ID is a code assigned to each user for identification of the user in the mail system, such as the mail server 100. Thus, an arbitrary text string can be used as the user ID as long as the user ID allows unique identification of the user. The user name is a name of a user who belongs to the organization 30 and who uses the mail system.

The group ID is a code assigned to each group for identification of the group in the mail system. Thus, similarly to the user ID, an arbitrary code can be used as the group ID as long as the group ID allows unique identification of the group.

The status indicates the validity of the user ID. A “valid” status indicates that the user ID is usable. On the other hand, an “invalid” status indicates that the use of the user ID has been invalidated.

Each user can belong to one or more groups. In this embodiment, when a user belongs to a plurality of groups, a plurality of pieces of association information is created for the user, for example, as shown in the first and second rows from the top of the association table 151a shown in FIG. 5, so that the same user ID is associated with different group IDs individually in the pieces of association information.

Next, a group table used by the mail server 100 according to this embodiment will be described.

FIG. 6 is a diagram showing the data structure of a group table. The group table 152a shown in FIG. 6 is created and managed by the mail server 100. The group table 152a stores group information indicating information regarding each group of the organization 30.

The group table 152a includes “group ID” indicating an ID of each group of the organization 30, “group name” indicating a name of the group, “representative account ID” indicating a representative account ID for identifying a mail address assigned to the group, and “status” indicating the validity of the group ID. The items of information in each row are associated with each other to constitute group information.

As described earlier, the group ID is a code assigned to each group for identification of the group in the mail system. The group name is a name of each group of the organization 30 that uses the mail system.

The representative account ID is a code assigned to each group in order to associate the group with a representative address assigned to the group. Thus, similarly to the group ID, an arbitrary text string can be used as the representative account ID as long as the representative account ID allows unique identification of the group.

The status indicates the validity of the group ID. A “valid” status indicates that the group ID is usable. On the other hand, an “invalid” status indicates that the use of the group ID has been invalidated.

Next, an address table used by the mail server 100 according to this embodiment will be described.

FIG. 7 is a diagram showing the structure of an address table. The address table 153a shown in FIG. 7 is created and managed by the mail server 100. The address table 153a stores address information indicating address information of each user and each group of the organization 30.

The address table 153a includes “account ID” indicating a user ID of a user having a mail address or a group ID of a group having a mail address, “name” indicating a name of the user or group, and “address” indicating the mail address assigned to the user or group. The items of information in each row are associated with each other to constitute address information.

The account ID is a code assigned to each user and each group in order to associate each user with a mail address assigned to the user and each group with a representative mail address assigned to the group in the address table 153a. The name is a name of the user or group. The address is the mail address assigned to the user or the representative mail address assigned to the group.

In this embodiment, each group can have one representative address. Without limitation, however, each group may have two or more representative addresses assigned thereto. In this case, a plurality of pieces of address information is created for the same group, so that the same account ID (representative address ID) is associated with different representative mail addresses in the individual pieces of address information.

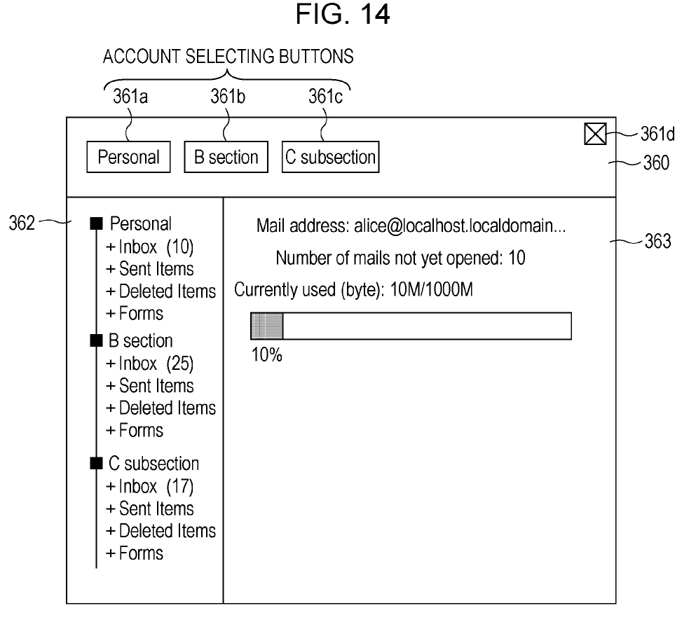

E-mails received at personal addresses and e-mails received at representative addresses are managed and stored in the mail-information storage unit on an account-by-account basis. When a user issues a request for an e-mail operation from one of the terminal apparatuses 31, 32, . . . that the user uses to the mail server 100, on the basis of the association information, group information, and address information shown in FIGS. 5 to 7, for each account at which the user is allowed to perform operations, mail information is provided to the terminal apparatus that the user uses, and mail bodies, the presence or absence of unopened mails, the number of unopened mails, and so forth are displayed on a browser on an account-by-account basis (see FIGS. 14 to 21). The user who performs e-mail operations can perform operations involving e-mails displayed on the browser.

Now, identification of a group ID on the basis of a user ID with reference to the account information will be described. As described above, the account information allows identification of an account at which a user is allowed to perform e-mail operations. The account information includes association information, group information, and address information stored in the association table 151a (see FIG. 5), the group table 152a (see FIG. 6), and the address table 153a (see FIG. 7), respectively.

The identification of a group ID on the basis of a user ID with reference to the account information is performed as follows by using the association table 151a, the group table 152a, and the address table 153a.

First, a user inside the organization 30 who operates one of the terminal apparatuses 31, 32, . . . logs in by using a user ID that is set as the account ID in the address table 153a. Then, on the basis of the user ID used for log in, a group ID associated with the user ID is obtained with reference to the association table 151a. Then, on the basis of the group ID, a representative account ID of the group corresponding to the group ID is obtained with reference to the group table 152a. Then, on the basis of the representative account ID, a mail address corresponding to the representative account ID is obtained again with reference to the address table 153a.

For example, in a case where a personal user “Alice” has logged in with a user ID (account ID) “1” (see the address table 153a shown in FIG. 7), the user ID “1” is associated with group IDs “10” and “11” (see the association table 151a shown in FIG. 5). The group IDs “10” and “11” are associated with a representative account ID “6” corresponding to a group name “A committee” and a representative account ID “7” corresponding to a group name “B section”, respectively (see the group table 152a shown in FIG. 6). Furthermore, these representative account IDs “6” and “7” are associated with a representative address “A_committee@. . . ” of the A committee and a representative address “B_section@. . . ” of the B section, respectively.

Thus, the account information indicates that, in this mail system, Alice is allowed to perform operations involving e-mails received at the representative addresses of the A committee and the B section.

FIG. 8 is a diagram showing the data structure of a mail management table. The mail management table 161a shown in FIG. 8 is created and managed by the mail server 100. The mail management table 161a stores mail management information indicating a mail number assigned to each e-mail received by the mail server 100 and a folder in which the received e-mail is classified. As described earlier, e-mails include both internal mails and external mails.

The mail management table 161a includes “mail number” indicating a number uniquely assigned to each e-mail received at a representative address for the purpose of identification of the e-mail, and “folder” indicating a folder in which the e-mail is classified. The items of information in each row are associated with each other to constitute mail management information.

The mail number is a number uniquely assigned to each e-mail received at a representative address of the mail server 100 for the purpose of identification of the e-mail by the mail server 100. The mail number of an external mail is assigned at the time of reception of the external mail by the mail server 100 via the Internet 20. The mail number of an internal mail is assigned at the time of storage at the mail server 100 of the internal mail sent via the LAN 10 to the mail server 100.

The folder is a number indicating a folder in which the received e-mail is classified by the mail server 100. Folders to which e-mails are classified include “inbox”, in which ordinary mails are classified, and “complaints”, in which mails of inquiries, complaints, and so forth are classified.

Each time an external mail sent from the outside of the organization 30 is received and each time an internal mail is created inside the organization 30, the mail server 100 creates mail management information as shown on each row of the mail management table 161a.

FIG. 9 is a diagram showing the data structure of a status management table. The status management table 162a shown in FIG. 9 is created and managed by the mail server 100. The status management table 162a stores status management information indicating whether each e-mail received by the mail server 100 has been opened by each user, has been replied to by each user, date and time of opening, and date and time of reply. As described earlier, e-mails include both internal mails and external mails.

The status management table 162a includes “mail status management ID” uniquely identifying status management information in order to manage the status of opening and status of reading of each received e-mail by each user, “mail number” indicating a number uniquely assigned to the e-mail, “group ID” indicating a group corresponding to the representative address to which the e-mail identified by the mail number is addressed, “user ID” indicating a user who has opened the e-mail identified by the mail number, “status” indicating the status of opening and reply of the e-mail identified by the mail number, “date and time of opening” indicating whether the e-mail identified by the mail number has been opened by the user identified by the user ID and a date and time of opening, and “date and time of reply” indicating whether the e-mail identified by the mail number has been replied to by the user identified by the user ID and a date and time of reply. The items of information in each row are associated with each other to constitute status management information. A piece of status management information is created for each user at a destination of a received e-mail.

The mail status management ID is a code for managing the status of opening and reply by each user in the organization 30 regarding each e-mail received by the mail server 100. The mail status management ID is uniquely assigned to each piece of status management information.

As described earlier, the mail number is a number uniquely assigned by the mail server 100 to each e-mail received by the mail server 100 for the purpose of identification of the e-mail.

The group ID indicates a group corresponding to a representative address that is the destination of the e-mail identified by the mail number.

The user ID indicates a user who is allowed to open and reply to e-mails at an account corresponding to the representative address to which the e-mail identified by the mail number is addressed. That is, the mail address to which the e-mail identified by the mail number is addressed is obtained, and users that are allowed to open and reply to e-mails of the group account corresponding to the mail address are listed. That is, the status management information is created for each user having a possibility of opening and replying to the e-mail.

The status indicates whether the e-mail identified by the mail number has been opened by the user identified by the user ID, and if the e-mail has been opened, whether the e-mail has been replied to. If the e-mail has not been opened by the user, “not yet opened” is set. If the mail has been opened but has not been replied to, “not yet replied” is set. If the user is creating a reply mail to the e-mail, “currently being created” is set. If the e-mail has been replied to, “already replied” is set.

The date and time of opening indicates a date and time when the user identified by the user ID opened the e-mail identified by the mail number. If the user has not opened the e-mail, the date and time of opening is left blank.

The date and time of reply indicates a date and time when the user identified by the user ID replied to the e-mail identified by the mail number. If the user has not replied to the e-mail, the date and time of reply is left blank.

The mail server 100 creates status management information corresponding to a row of the status management table 162a each time an external mail sent from the outside of the organization 30 is received and each time an internal mail is created inside the organization 30. Since the e-mail is not yet opened at this time, “not yet opened” is set as the status.

As described above, the status management information is created individually for each e-mail received and for each account of a user allowed to read e-mails at a representative account. That is, the status management information is created for each user allowed to read e-mails at a representative address, for example, like the status management information on the first and second rows of the status management table 162a shown in FIG. 9.

Then, upon the user reading an e-mail, the mail server 100 obtains the date and time of opening. Furthermore, the mail server 100 sets “not yet replied”, indicating that the e-mail has been opened, as the status in the status management information corresponding to the mail number assigned to the e-mail read by the user and the user ID indicating the account of the user who has opened the e-mail, and sets the date and time of opening that has been obtained as the date and time of opening.

Furthermore, upon the user replying to the e-mail, the mail server 100 obtains the date and time of reply. Furthermore, the mail server 100 sets “already replied”, indicating that the e-mail has been replied to, as the status in the status management information corresponding to the mail number assigned to the e-mail and the user ID indicating the account of the user who has replied to the e-mail, and sets the date and time of reply obtained as the date and time of reply.

The status management information maintains records as to whether each e-mail managed by the mail server 100 has been opened and has been replied to by each user. As described above, the status management information functions as reply history information and opening date and time information as well as mail status information. Thus, with the mail server 100 according to this embodiment, it is possible to manage whether each user has read each e-mail and whether each user has replied to each e-mail.

FIG. 10 is a diagram showing the data structure of a comment management table. The comment management table 163a shown in FIG. 10 is created and managed by the mail server 100. The comment management table 163a stores comment management information indicating a date and time of creation of comment by a user and the content of the comment created for each e-mail received by the mail server 100. As described earlier, e-mails include both internal mails and external mails.

The comment management table 163a includes “comment management ID” uniquely identifying comment management information in order to manage the status of creation of comment by each user who has received an e-mail, “mail number” indicating a number uniquely assigned to each received e-mail for the purpose of identification of the e-mail, “group ID” indicating a group corresponding to a representative address to which the e-mail identified by the mail number is addressed, “user ID” indicating a user who created comment for the e-mail identified by the mail number, “date and time of creation of comment” indicating a date and time of creation of comment by the user identified by the user ID for the e-mail identified by the mail number, and “comment” indicating the content of the comment created by the user identified by the user ID for the e-mail identified by the mail number. The items of information in each row are associated with each other to constitute comment management information. The comment management information is created each time comment is created by a user for a received e-mail.

The comment management ID is a code for managing comment created by a user in the organization 30 for an e-mail received by the mail server 100. The comment management ID is uniquely assigned to each piece of comment management information.

As described earlier, the mail number is a number uniquely assigned by the mail server 100 to each e-mail received by the mail server 100 for the purpose of identification of the e-mail.

The group ID indicates a group corresponding to the representative address to which the e-mail identified by the mail number is addressed.

The user ID indicates a user who created comment for the e-mail identified by the mail number. The comment management information is created for each user who created comment for the e-mail.

The date and time of creation of comment indicates a date and time of creation of comment by the user identified by the user ID for the e-mail identified by the mail number.

The mail server 100 creates comment management information corresponding to a row of the comment management table 163a each time comment is created for an external mail sent from the outside of the organization 30 or an internal mail created inside the organization 30.

The comment is used only within the organization 30 or within a subgroup of the organization 30. That is, the comment is internal information that can be read only by users within the organization 30 or within a subgroup of the organization 30. The comment is created for an e-mail received at a representative address, at the time of creating a reply mail to the e-mail or otherwise as needed by a user. The comment that has been created is associated with the corresponding e-mail so that the comment can be referred to by the user himself or herself and other users who are allowed to read e-mails at the representative address as reference for dealing with the content of the e-mail. Therefore, basically, those who are not allowed to read e-mails at the representative address, such as the sender of the e-mail associated with the comment, are not allowed to refer to the comment.

The comment management information maintains records as to whether any comment has been created by each user for each e-mail managed by the mail server 100 and the comment created. As described above, the comment management information functions as comment information. Thus, with the mail server 100 according to this embodiment, it is possible to manage comment created by each user for each e-mail received.

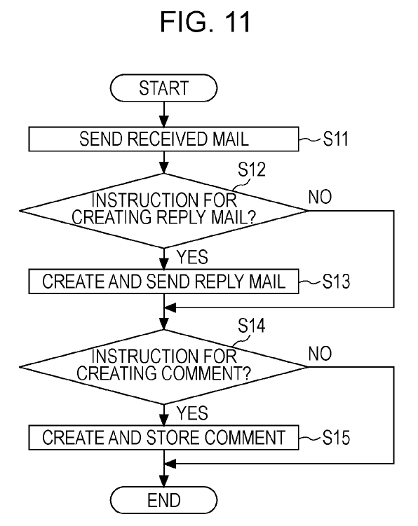

Next, a procedure of processing in the mail system according to this embodiment will be described. First, a mail reading process that is executed at the mail server 100 according to this embodiment when a user reads an e-mail received by the mail server 100 will be described. FIG. 11 is a flowchart showing the procedure of the mail reading process.

Upon receiving an e-mail display request sent from one of the terminal apparatuses 31, 32, . . . (e.g., the terminal apparatus 31) used by a user belonging to the organization 30, the mail server 100 according to this embodiments executes the mail reading process to provide the terminal apparatus with information of received e-mails addressed to the user and displays the information on a browser at the terminal apparatus.

In step S11, upon receiving an e-mail display request from the user of the terminal apparatus 31, the CPU 101 of the mail server 100 sends mail information of the received mails relevant to the request to the terminal apparatus 31 via the LAN 10. Upon receiving the mail information, the terminal apparatus 31 displays the received mails on the basis of the received mail information.

In step S12, the CPU 101 determines whether a reply-mail creating instruction sent from the terminal apparatus 31 in response to a user's operation has been accepted. If such an instruction has been accepted, the process proceeds to step S13. On the other hand, if such an instruction has not been accepted, the process proceeds to step S14.

In step S13, on the basis of the instruction accepted in step S12, the CPU 101 lets the user create a reply mail to one of the received mail and sends the reply mail created.

In step S14, the CPU 101 determines whether a comment creating instruction sent from the terminal apparatus 31 in response to a user's operation has been accepted. If a comment creating instruction has been accepted, the process proceeds to step S15. On the other hand, if a comment creating instruction has not been accepted, the process is exited.

In step S15, on the basis of the comment creating instruction accepted in step S14, the CPU 101 lets the user create comment regarding the received mail or reply mail and stores the comment created in the comment-management-information storage unit 163.

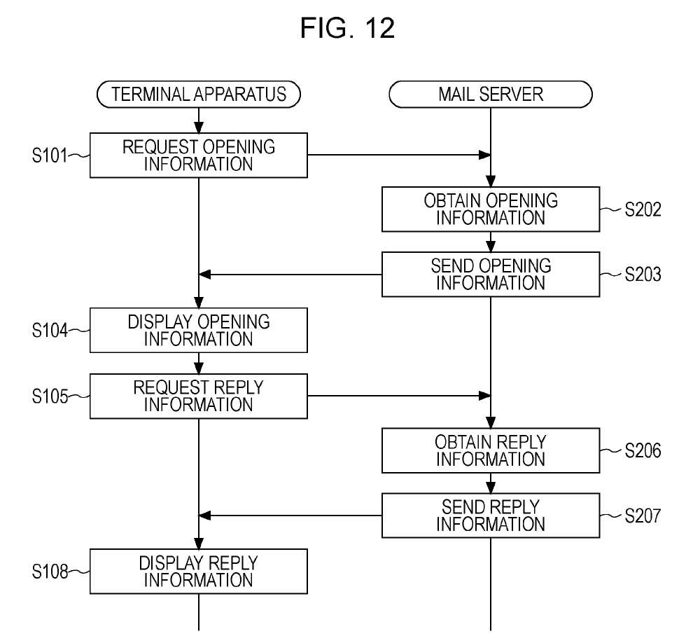

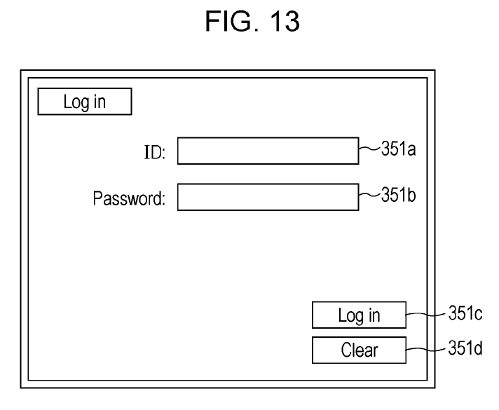

Next, a process of displaying information regarding the status of opening of an e-mail and the status of reply to the e-mail by users in the mail system according to this embodiment will be described. FIG. 12 is a sequence diagram showing the procedure of the process of displaying information regarding the status of opening of an e-mail and the status of reply to the e-mail.

The following describes the procedure of a process that is executed in the mail system according to this embodiment in a case where the status of opening and reply history of an e-mail are displayed on a browser of one of the terminal apparatuses 31, 32, . . . (e.g., the terminal apparatus 31) inside the organization 30 by a user inside the organization 30. The e-mail here may be either an external mail sent from one of the terminal apparatuses 21, 22, 23, . . . outside the organization 30 to a user or group inside the organization 30 or an internal mail created for a user or group inside the organization 30 at one of the terminal apparatuses 31, 32, . . . inside the organization 30.

In step S101, upon accepting an operation of the browser by a user inside the organization 30 for displaying the status of opening of an e-mail, the terminal apparatus 31 sends a request for the opening status information to the mail server 100 via the LAN 10.

In step S202, upon receiving the request for opening status information sent from the terminal apparatus 31 via the LAN 10, in response to the request received, the mail server 100 obtains opening information of the e-mail relevant to the user's request from the mail-status-information storage unit 160.

In step S203, the mail server 100 sends the opening information of the e-mail relevant to the request by the user to the terminal apparatus 31 via the LAN 10.

In step S104, upon receiving the opening information sent from the mail server 100 via the LAN 10, on the basis of the opening information received, the terminal apparatus 31 displays an opening-status display screen (see FIG. 18) indicating the status of opening.

In step S105, upon accepting an operation of the browser by the user for displaying reply history of the e-mail, the terminal apparatus 31 sends a request for reply information to the mail server 100 via the LAN 10.

In step S206, upon receiving the request for reply information sent from the terminal apparatus 31 via the LAN 10, in response to the reply information request received, the mail server 100 obtains reply information of the e-mail relevant to the user's request from the mail-status-information storage unit 160.

In step S207, the mail server 100 sends the reply information of the e-mail relevant to the user's request to the terminal apparatus 31 via the LAN 10.

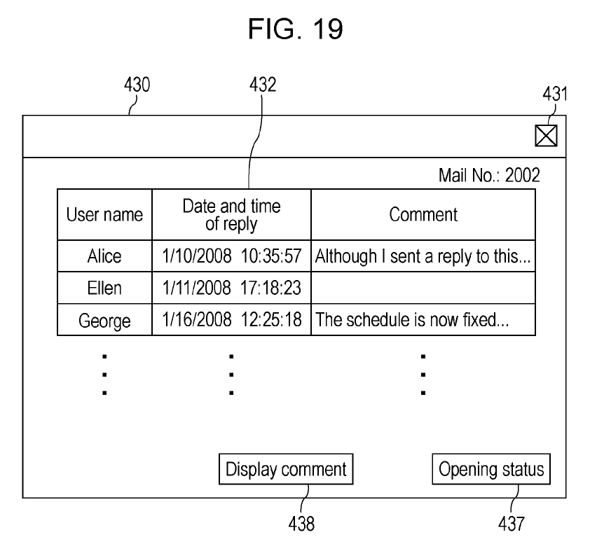

In step S108, upon receiving the reply information sent from the mail server 100 via the LAN 10, on the basis of the reply information received, the terminal apparatus 31 displays a reply-history display screen 430 (see FIG. 19) indicating the status of reply.

Next, display screens displayed on the browsers of the terminal apparatuses 31, 32, . . . in the mail system according to this embodiment will be described.

FIG. 13 is an illustration showing a log-in screen. A log-in screen 350 shown in FIG. 13 is an example of a log-in screen displayed on a browser on a monitor (not shown) connected to one of the terminal apparatuses 31, 32, . . . (e.g., the terminal apparatus 31) operated by a user inside the organization 30 when the user performs a log-in operation for logging into the mail system in order to perform e-mail operations.

The log-in screen 350 includes an ID input field 351a, a password input field 351b for accepting input of a password, a log-in button 351c for accepting an operation for causing the mail server 100 to execute account authentication for log in when the ID and password input to the ID input field 351a and the password input field 351b are valid, and a clear button 351d for accepting an operation for canceling information that has been input when the ID and password input to the ID input field 351a and the password input field 351b are not valid.

A user who logs into the mail system inputs a user ID assigned in advance to the ID input field 351a and a password associated with the user ID to the password input field 351b, and then operates the log-in button 351c. Accordingly, the mail server 100 executes account authentication, so that the user is allowed to log into the mail system.

FIG. 14 is an illustration showing a post-log-in screen. A post-log-in screen 360 shown in FIG. 14 is an example of a post-log-in screen displayed on the browser on the monitor (not shown) connected to one of the terminal apparatuses 31, 32, . . . (e.g., the terminal apparatus 31) operated by the user in the organization 30 immediately after the user logs into the mail system to perform e-mail operations.

The post-log-in screen 360 includes account selecting buttons 361a, 361b, and 361c for accepting an operation for selecting an account, a close button 361d for accepting an operation for finishing an e-mail operation, a folder display area 362 for displaying the status of e-mail folders at accounts at which the user is allowed to perform operations, and an account-information display area 363 for displaying the status of reception of e-mails at the account that the user has logged into.

In the folder display area 362, accounts at which the user is allowed to perform operations (e.g., “personal”, “B section”, and “C subsection”), and folders at the accounts (e.g., “inbox”, “sent items”, “deleted items”, and “forms”) are displayed.

In the folder display area 362, for each of the personal and representative addresses corresponding to the accounts at which the user is allowed to perform operations, the number of unopened (unread) mails at the account is displayed on a folder-by-folder basis.

More specifically, referring to FIG. 14, “Inbox (10)” for the personal address indicates that 10 unopened mails exist in the inbox folder of the personal address. Furthermore, “Inbox (25)” for the B section indicates that 25 unopened mails exist in the user's account at the representative address of the B section. The presence or absence and the number of unopened e-mails are determined by the mail server 100 with reference to the status management information stored in the status management table 162a (see FIG. 9).

In the account-information display area 363, the mail address of the account that the user has logged into, and the status of reception at the mail address, such as the number of unopened mails and the amount of storage currently used, are displayed. For example, in the case where the user has logged in with the personal address, the status of reception at the personal address is displayed in the account-information display area 363.

The user who has logged into the mail system can recognize the presence or absence of unopened mails and the number of unopened mails at each account with reference to the folder display area 362. In the case where the user performs e-mail operations at an account having any unopened mail, the user can switch to a received-mail display screen 370, which will be described later in detail with reference to FIG. 15, by operating one of the account selecting buttons 361a, 361b, and 361c corresponding to an account at which the user wishes to perform e-mail operations. If the user does not wish to perform e-mail operations at any of the accounts, the user can log out of the mail system by operating the close button 361d.

FIG. 15 is an illustration showing a received-mail display screen. A received-mail display screen 370 shown in FIG. 15 is an example of a received-mail display screen displayed on the browser on the monitor (not shown) connected to one of the terminal apparatuses 31, 32, . . . (e.g., the terminal apparatus 31) operated by a user inside the organization 30 operated by the user inside the organization 30, showing e-mails received at a representative address.

Similarly to the post-log-in screen 360, the received-mail display screen 370 includes account selecting buttons 371a, 371b, and 371c, a close button 371d, and a folder display area 372. Furthermore, in the received-mail display screen 370, a list display area 373 for displaying a list of e-mails in a folder selected in the folder display area 372, a body display area 374 for displaying the body of an e-mail selected in the list display area 373, a reply button 375 that is operated by the user when the user creates a reply to the e-mail displayed in the body display area 374, an opening status button 376 that is operated by the user to display the status of opening of the e-mail displayed in the body display area 374, a reply history button 377 that is operated by the user to display the reply history of the e-mail displayed in the body display area 374, and a comment creating button 378 that is operated by the user to create comment for the e-mail displayed in the body display area 374 are provided.

In FIG. 15, the account selecting button 371b, corresponding to the representative account of the B section, is displayed in white. On the other hand, the other account selecting buttons 371a and 371c are displayed as shaded. This indicates that the account of e-mails displayed in the list display area 373 is the representative account of the B section. The user can switch the e-mails displayed to e-mails of other accounts corresponding to the account selecting buttons 371a and 371c by operating the account selecting buttons 371a and 371c. Furthermore, the user can log out of the mail server and close the display of e-mails by operating the close button 371d.

When the user wishes to view the body of an e-mail with reference to the list of e-mails displayed in the list display area 373, the user selects the e-mail from the list displayed in the list display area 373, whereby the body of the e-mail selected is displayed in the body display area 374. Furthermore, when the e-mail is selected by the user for the first time, the selected e-mail becomes “opened”, and the status management information is updated in accordance with the opening.

When the user has read an e-mail at the representative account, displayed in the body display area 374, and then wishes to create a reply to the e-mail, the user can create a reply mail by operating the reply button 375 to open a reply-mail creating screen 380, which will be described later in detail with reference to FIG. 16.

When the user has read the e-mail at the representative account, displayed in the body display area 374, and then wishes to check the status of opening of the e-mail, the user can check the status of opening by operating the opening status button 376 to open an opening-status display screen 420, which will be described later in detail with reference to FIG. 18.

When the user who has read the e-mail at the representative account, displayed in the body display area 374, then wishes to check the reply history of the e-mail, the user can check the reply history by operating the reply history button 377 to open a reply-history display screen 430, which will be described later with reference to FIG. 19.

When the user has read the e-mail at the representative account, displayed in the body display area 374, and then wishes to create comment for the e-mail, the user can create comment for the e-mail by operating the comment creating button 378 to open a comment creating screen (not shown).

FIG. 16 is an illustration showing a reply-mail creating screen. A reply-mail creating screen 380 shown in FIG. 16 is an example of a reply-mail creating screen displayed on the browser on the monitor (not shown) connected to one of the terminal apparatuses 31, 32, . . . (e.g., the terminal apparatus 31) operated by the user inside the organization 30 when the user creates a reply mail to an e-mail that the user has read.

The reply-mail creating screen 380 includes a close button 381, a source-address input field 382 for accepting input of a sender address at the source of the reply mail (reply source), a body input area 383 for accepting input of a body of the reply mail, and a send button 384 that is operated by the user when sending the reply mail that has been created.

Furthermore, in the list display area 373, on the basis of the status management information (see FIG. 9), “opened by” indicating the number of users who have opened the e-mail received at the representative address, and “status, indicating whether the e-mail has been replied to by any one of the users, are displayed for each e-mail.

The “status” is determined by logical addition of the statuses of reply by individual users. That is, the status is set to “already replied” if any one of the users allowed to read the e-mail has already replied to the e-mail. The status is set to “currently being replied” if any one of the users is already creating a reply mail. The status is set to “not yet replied” if no user has replied or is creating a reply mail. Without limitation to these statuses, as the “status”, the reply history of the user at the account for which the received-mail display screen is displayed may be displayed.

Referring to FIG. 15, when the user has read the e-mail displayed in the body display area 374 and then wishes to create a reply mail to the e-mail, the user operates the reply button 375 to open the reply-mail creating screen on the browser at the terminal apparatus 31. The user can create a reply mail to the e-mail by entering a mail body in the body input area 383.

In the source-address input field 382, the mail address of the account at which the e-mail to which a reply mail is being created was read is input in advance. More specifically, for example, as shown in FIG. 15, when the user creates a reply mail to an e-mail read at a representative account, as shown in FIG. 16, the representative address, i.e., the mail address of the representative account at which the e-mail was read, is input as a source address. When the user creates a reply mail to an e-mail browsed at the personal account, the personal address, i.e., the mail address of the personal account at which the e-mail was read, is input as a source address.

Now, a process for setting a source address will be described.

Upon accepting an instruction for creating a reply mail to an e-mail at an account at which a user is allowed to perform operations by using a browser, the terminal apparatus 31 sends a reply-mail creating request to the mail server 100 via the LAN 100.

Upon receiving the reply-mail creating request sent from the terminal apparatus 31, as a source address of a reply mail, the mail server 100 sets the mail address of the account at which the e-mail being replied to was received and the user issued the reply-mail creating instruction. With this setting, by using the browser of the terminal apparatus 31, the user creates a reply mail in which the address at which the e-mail being replied to was received is set as a source address.

Thus, an appropriate source address is set to the reply mail created by the mail system. Accordingly, it is possible to prevent a mistake of sending an e-mail in which another account of the user is set as a source address (sender). This serves to prevent corresponding leakage of a personal address to the outside. For example, it is possible to prevent it from being accidentally known to the outside which user in the organization 30 sent the e-mail, so that personal information can be protected.

In the embodiment described above, the mail server 100 sets a reply address before a user creates a reply mail. Without limitation, however, the mail server 100 may automatically change a reply address to a mail address of a corresponding account after a user creates a reply mail and issues a sending instruction, and then send the reply mail to a destination. Yet alternatively, instead of automatically changing the reply address, the mail server 100 may display an alert message or a confirmation message for the user or send an alert message or a confirmation message to a third party in a case where the destination address of the e-mail received does not coincide with the reply address of the reply mail created by the user. Furthermore, these schemes may be used in combination with each other.

The user can quit creating the reply mail on the reply-mail creating screen 380 by operating the close button 381 to close the display of the reply-mail creating screen 380.

FIG. 17 is an illustration showing a comment creating screen. A comment creating screen 410 shown in FIG. 17 is an example of a comment creating screen that is displayed on the browser on the monitor (not shown) connected to one of the terminal apparatuses 31, 32, . . . (e.g., the terminal apparatus 31) operated by a user inside the organization 30 when the user creates comment for an e-mail received at a representative address and read by the user.

The comment creating screen 410 includes a close button 411, a reply-mail-information display area 412 for displaying information regarding a reply mail created for a received mail, a reply-mail-body display area 413 for displaying a body of the reply mail, a comment input area 414 for accepting input of comment created, and an OK button that is operated by the user when the user has finished creating comment.

Upon the user sending a reply mail in the reply-mail creating screen 380 shown in FIG. 16 for an e-mail received at the representative address, the comment creating screen 410 is opened on the browser at the terminal apparatus 31. The user can create comment for the e-mail by entering comment to the comment input area 414 of the comment creating screen 410. Comment information is updated in accordance with the comment created.

The user can quit creating comment in the comment creating screen 410 by operating the close button 411 to close the display of the comment creating screen 410.

FIG. 18 is an illustration showing an opening-status display screen. An opening-status display screen 420 shown in FIG. 18 is an example of an opening-status display screen showing the status of opening of an e-mail received at the representative address, which is displayed on the browser on the monitor (not shown) connected to one of the terminal apparatuses 31, 32, . . . (e.g., the terminal apparatus 31) that is operated by a user inside the organization 30.

The opening-status display screen 420 includes a close button 421, an opening-status display area 422 showing the status of opening of an e-mail selected by a user's operation to display the status of opening, and a reply history button 427 that is operated by the user to display a reply history of the e-mail whose status of opening is displayed in the opening-status display screen 420.

In the opening-status display area 422, the status of opening of the e-mail is displayed on the basis of the status management information (see FIG. 9). More specifically, in the opening-status display area 422, “User name” indicating the name of each user who opened the e-mail whose status of opening is displayed, “Date and time of opening” indicating the date and time when the user identified by the user name opened the e-mail, and “Date and time of reply” indicating the date and time when the user identified by the user name sent a reply to the e-mail. The date and time of reply is displayed only when the user has sent a reply to the e-mail, and is left blank when the user has not sent a reply.

The user can close the display of the status of opening in the opening-status display screen 420 by operating the close button 421.

If the user wishes to check the reply history of the e-mail after viewing the status opening of the e-mail displayed in the opening-status display screen 420, the user operates the reply history button 427 to open a reply-history display screen 430 described below with reference to FIG. 19, so that the user can check the reply history of the e-mail whose status of opening is displayed.

FIG. 19 is an illustration showing a reply-history display screen. A reply-history display screen 430 shown in FIG. 19 is an example of reply-history display screen showing a reply history of an e-mail received at the representative address, which is displayed on the browser on the monitor (not shown) connected to one of the terminal apparatuses 31, 32, . . . (e.g., the terminal apparatus 31) that is operated by a user inside the organization 30.

The reply-history display screen 430 includes a close button 431, a reply-history display area 432 showing a reply history of an e-mail selected by a user's operation to display a reply history, an opening status button 436 that is operated by the user to display the status of opening of the e-mail whose reply history is displayed in the reply-history display screen 430, and a comment display button 438 that is operated by the user to display comment for the e-mail whose reply history is displayed in the reply-history display screen 430.

In the reply-history display area 432, a reply history of and comment for the e-mail are displayed on the basis of the status management information (see FIG. 9) and the comment management information (see FIG. 10). More specifically, in the reply-history display area 432, “User name” indicating the name of each user who replied to the e-mail whose reply history is displayed, “Date and time of reply” indicating the date and time when the user identified by the user name sent a reply to the e-mail, and “Comment” indicating comment created for the e-mail by the user identified by the user name. The comment is displayed only when the user has created comment for the e-mail, and is left blank when the user has not created comment.

The user can close the display of the reply history in the reply-history display screen 430 by operating the close button 431.

If the user wishes to check the status of opening of the e-mail after viewing the reply history of the e-mail displayed in the reply-history display screen 430, the user can check the status of opening of the e-mail whose reply history is displayed by operating the opening status button 436 to open the opening-status display screen 420 described earlier.

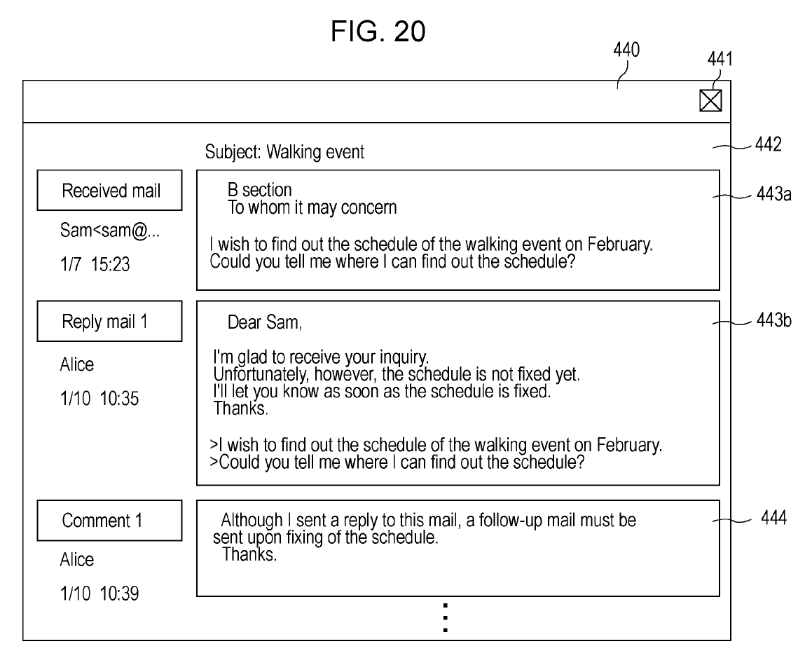

If the user wishes to check the details of comment for the e-mail after viewing the reply history of the e-mail displayed in the reply-history display screen 430, the user can check the details of comment for the e-mail whose reply history is displayed by operating the comment display button 438 to open a comment display screen 440 described below in detail with reference to FIG. 20.

FIG. 20 is an illustration showing a comment display screen. A comment display screen 440 shown in FIG. 20 is an example of a comment display screen showing comment for an e-mail received at the representative address and read by a user inside the organization 30, which is displayed on the browser on the monitor (not shown) connected to one of the terminal apparatuses 31, 32, . . . (e.g., the terminal apparatus 31) that is operated by the user.

The comment display screen 440 includes a close button 441, a received-mail-information display area 442 for displaying information regarding the received mail for which comment was created, a received-mail display area 443a for displaying information regarding the received e-mail, a reply-mail display area 443b for displaying information regarding a reply mail to the received e-mail, and a comment display area 444 for displaying comment for the received e-mail.

Upon an operation of the comment display button 438 in the reply-history display screen 430 shown in FIG. 19, the comment display screen 440 is opened on the browser of the terminal apparatus 31. The user can check the details of comment for the received e-mail, included in the comment management information (see FIG. 10), with reference to the comment display area 444 of the comment display screen 440.

Next, another example of a display screen in this embodiment will be described.

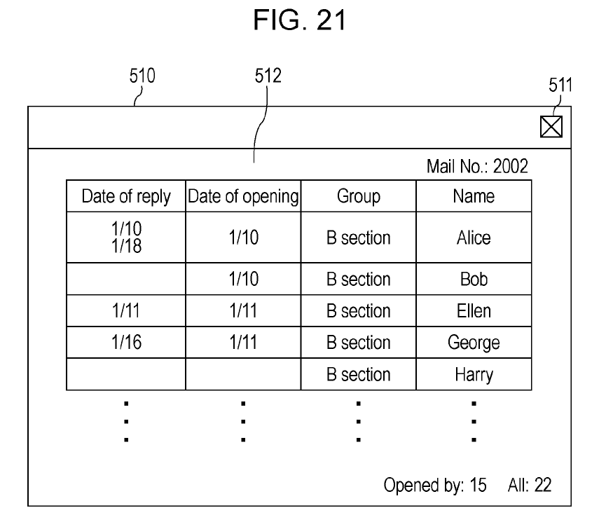

FIG. 21 is an illustration showing a mail-status display screen. A mail-status display screen 510 shown in FIG. 21 is an example of a mail-status display screen showing a reply history of an e-mail received at a representative address, which is displayed on the browser on the monitor (not shown) connected to one of the terminal apparatuses 31, 32, . . . (e.g., the terminal apparatus 31) that is operated by a user inside the organization 30.

The mail-status display screen 510 shown in FIG. 21 shows a list of the status of opening and reply history of individual users regarding the e-mail received at the representative address.

The mail-status display screen 510 includes a close button 511, and a mail-status display area 512 for displaying the status of opening and reply history of the e-mail received at the representative address.

In the mail-status display area 512, the status of opening and reply history of the e-mail are displayed on the basis of the status management information. The mail-status display area 512 includes “Date of reply” indicating the date when each user identified by a name sent a reply to the received e-mail, “Date of opening” indicating the date when the user identified by the name opened the received e-mail, “Group” indicating the group to which the user identified by the name belongs, and “Name” indicating each user allowed to read the received e-mail.

The name is displayed for each user allowed to read the e-mail. The date of reply is displayed only when the user has sent a reply to the e-mail, and is left blank when the user has not sent a reply. The date of opening is displayed only when the user has opened the e-mail, and is left blank when the user has not opened the e-mail.

Furthermore, in a lower part of the mail-status display area 512, “Opened by” indicating the number of users who opened the e-mail among the users allowed to read the e-mail, and “All” indicating the number of users allowed to read the e-mail are displayed. Thus, it is possible to recognize an overview of the status of opening by the group as a whole.

In the mail system according to this embodiment, a status display button (not shown) may be provided in the received-mail display screen 370 shown in FIG. 15 so that the mail-status display screen 510 is displayed on the browser of one of the terminal apparatuses 31, 32, . . . upon a user's operation of the status display button. This makes it readily possible for a user of the mail system to recognize an overview of the status of opening and reply history of an e-mail received at a representative address on a per-user basis within a group.

The user can close the display of the status of opening and reply history by operating the close button 511.

Although only the date of reply and date of opening are displayed in the mail-status display screen 510, the hour, minute, and second of reply and opening may be displayed further. Furthermore, information regarding a plurality of e-mails may be displayed simultaneously. Furthermore, the status of only specific users, such as group leaders or newcomers, may be selectively displayed. Furthermore, information regarding only users in a specific status, such as users who have not opened the e-mail or who has replied to the e-mail, may be selectively displayed or displayed as highlighted by markers or the like.

As described above, with the mail server 100 according to this embodiment, it is possible to recognize whether each e-mail received at a representative address has been read by each user allowed to read e-mails at the representative address. Thus, it is readily possible to manage whether each e-mail has been read at the representative address.

Furthermore, since the list display area 373 for displaying the number of users who opened an e-mail received at a representative address and the opening status button 376 that is operated to display the status of opening are provided in the received-mail display screen 370, it is readily possible to recognize an overview of the status of opening of the e-mail received at the representative address by a group as a whole, and it is readily possible to check the details of the status of opening of the e-mail.

Furthermore, in existing mail systems, although it is possible to recognize a reply mail by logging in again by using an account corresponding to a representative address and checking a sent items box, it is not possible to identify who sent the reply mail. In contrast, with the mail server 100 according to this embodiment, it is readily possible to recognize when and who in a group sent a reply to an e-mail received at a representative address. Furthermore, since a reply history list is displayed without logging in again, inefficiency and confusion involving external mails are reduced, so that work efficiency can be improved.

Furthermore, since it is possible to perform switching of an e-mail account that a user uses to perform operations among a plurality of accounts without logging in again according to a switching instruction by the user, it is possible to perform switching of display regarding e-mails among a plurality of accounts according to a switching instruction by the user at a terminal apparatus inside the organization 30. This facilitates user's operations involving e-mails at a plurality of mail accounts.

Furthermore, since the presence or absence of any unopened mails and the number of unopened mails are displayed in the post-log-in screen 360 and the received-mail display screen even for an account different from an account for which mail information is displayed. Thus, without selecting all the accounts one by one, it is possible to determine whether mail information of other accounts should be displayed. This serves to reduce user's tasks for mail management.

Furthermore, users registered at the mail server 100 can readily share information regarding e-mails addressed to a representative address, which has not been possible in existing Web mail systems.

Furthermore, in addition to information displayed in existing systems when a user has logged in to a personal account, it is possible to visually recognize the status of reception of e-mails at a representative address.

Furthermore, the mail boxes of groups to which a user of an account used for log in belongs to can be displayed by operating the account selecting buttons 361a to 371c. Thus, when switching to another account to read e-mails at the account, the user need not perform log in again. This facilitates user's management of e-mails at a plurality of accounts.

Hereinabove, a mail sending and receiving program, a mail sending and receiving apparatus, and a mail sending and receiving system according to an embodiment of the present invention have been described. Although the above description explains the principle of the present invention merely, the present invention is not limited to the exact exemplary configurations and applications described above. It is to be understood that various modifications and alternatives can be conceived by those skilled in the art. All corresponding modifications, alternatives, and equivalents are considered as falling in the scope of the present invention as claimed and its equivalents. The configuration of individual parts can be replaced with arbitrary configurations having similar functions. Furthermore, arbitrary configurations or steps may be added when embodying the present invention. Furthermore, the present invention covers a combination of arbitrary two or more configurations (features) of the embodiments described above.

The above processing functions can be implemented by a computer. In that case, a program defining processing for intended functions of the mail server 100 is provided. The processing functions are implemented on a computer by executing the program on the computer.

The program defining the processing can be recorded on a computer-readable medium. The computer-readable medium is, for example, a magnetic recording medium, an optical disc, a magneto-optical recording medium, or a semiconductor memory. The magnetic recording medium is, for example, an HDD, an FD (flexible disk), or an MT (magnetic tape). The optical disc is, for example, a DVD (digital versatile disc), a DVD-RAM, a CD-ROM (compact disc read-only memory), or a CD-R (recordable)/RW (rewritable). The magneto-optical recording medium is, for example, an MO (magneto-optical disk).

In order to distribute the program, for example, a portable recording medium having the program recorded thereon, such as a DVD or CD-ROM, is sold. Alternatively, the program may be stored at a server computer and transferred from the server computer to another computer via a network.

For example, a computer that executes the program installs the program recorded on the portable recording medium or transferred from the server computer on a storage device of its own. Then, the computer reads the program from the storage device and executes processing according to the program. Alternatively, the computer may read the program directly from the portable recording medium and execute processing according to the program. Yet alternatively, the computer may execute processing according to the program each time upon receiving the program from the server computer.

What is claimed is:

1. A computer-readable medium comprising computer-executable instructions for performing a method, execution of which by a computer facilitates sending and receiving e-mails, the method including:
providing a memory including mail-status-information indicating whether a received e-mail has been opened;
detecting opening of the received e-mail;
updating the mail status information stored in the memory upon detection of the opening of the received e-mail;
accepting a status request for the mail status information; and
reading the mail status information from the memory and providing the same upon acceptance of the status request.

2. The computer-readable medium according to claim 1,
wherein the mail status information includes reply history information indicating whether a reply mail for the received e-mail has been sent,
wherein the method further includes detecting the reply mail for the received e-mail, and
wherein the updating of the mail-status-information includes updating the reply history information upon detection of the reply mail for the received e-mail.

3. The computer-readable medium according to claim 1,
wherein the mail status information includes comment information indicating a comment created by a user regarding the received e-mail,
wherein the method further includes at least the following,
accepting the comment regarding the received e-mail by the user, and
updating the comment information upon acceptance of the comment.

4. The computer-readable medium according to claim 1,
wherein the memory further includes account information, and the method further includes at least the following,
authenticating login by a user to an account at which the user manages e-mails; and
reading the account information from the memory, the account information identifying accounts at which the authenticated user is allowed to perform operations involving e-mails; and
determining accounts at which the authenticated user is allowed to open e-mails with reference to the account information,
wherein the mail status information indicates whether each e-mail received at any one of the accounts has been opened and which of one or more users has opened the e-mail,
detecting opening of each email and which of the one or more users has opened the e-mail, and
updating the mail status information on the basis of the detected opening and the one or more users who have opened the email.

5. The computer-readable according to claim 1,
wherein the mail status information includes opening date and time information indicating a date and time at which the opening of the received e-mail, and
wherein the updating of the mail-status-information includes updating the opening date and time information upon detection of the opening of the received e-mail.

6. A method to facilitate sending and receiving e-mails, the method comprising:
providing a memory including mail-status-information indicating whether a received e-mail has been opened;
detecting opening of the received e-mail;
updating the mail status information stored in the memory upon detection of the opening of the received e-mail;
accepting a status request for the mail status information; and
reading the mail status information from the memory and providing the same upon acceptance of the status request.

7. The method according to claim 6,
wherein the mail status information includes reply history information indicating whether a reply mail for the received e-mail has been sent,
wherein the method further includes detecting the reply mail for the received e-mail, and
wherein the updating of the mail-status-information includes updating the reply history information upon detection of the reply mail for the received e-mail.

8. The method according to claim 6,
wherein the mail status information includes comment information indicating a comment created by a user regarding the received e-mail,
wherein the method further includes at least the following,
accepting the comment regarding the received e-mail by the user, and
updating the comment information upon acceptance of the comment.

9. The method according to claim 6,
wherein the memory further includes account information, and the method further includes at least the following,
authenticating login by a user to an account at which the user manages e-mails; and
reading the account information from the memory, the account information identifying accounts at which the authenticated user is allowed to perform operations involving e-mails; and
determining accounts at which the authenticated user is allowed to open e-mails with reference to the account information,
wherein the mail status information indicates whether each e-mail received at any one of the accounts has been opened and which of one or more users has opened the e-mail,
detecting opening of each email and which of the one or more users has opened the e-mail, and
updating the mail status information on the basis of the detected opening and the one or more users who have opened the email.

10. The computer-readable according to claim 6,
wherein the mail status information includes opening date and time information indicating a date and time at which the opening of the received e-mail, and
wherein the updating of the mail-status-information includes updating the opening date and time information upon detection of the opening of the received e-mail.

11. A mail sending and receiving apparatus for sending and receiving e-mails, the apparatus comprising:
a memory to store mail status information indicating whether each e-mail has been opened;
an opening detecting unit to detect opening of a received e-mail;
a mail-status-information updating unit to update the mail status information stored in the memory upon detection of the opening of the received e-mail by the opening detecting unit;
a status-request accepting unit to accept a status request for the mail status information; and
a mail-status-information providing unit to read the mail status information from the memory and provide the same upon acceptance of the status request.

12. A mail sending and receiving system for sending and receiving e-mails, the system comprising:
a mail sending and receiving apparatus; and
a terminal apparatus connected to the mail sending and receiving apparatus via a communication circuit,
wherein the mail sending and receiving apparatus includes at least the following,
a memory to store mail status information indicating whether each e-mail has been opened;
an opening detecting unit to detect opening of a received e-mail;
a mail-status-information updating unit to update the mail status information stored in the memory upon detection of the opening of the received e-mail by the opening detecting unit;
a status-request accepting unit to accept a status request for the mail status information; and
a mail-status-information providing unit to read the mail status information from the memory and provide the same upon acceptance of the status request; and
wherein the terminal apparatus is further operable to output the status request to the mail sending and receiving apparatus in response to a user's operation and to display information based on the mail status information provided from the mail-status-information providing unit.
